(19) United States
(12) Patent Application Publication
(10) Pub. No.: US 2015/0057585 A1
(43) Pub. Date: Feb. 26, 2015

(54) COMPRESSION DEVICE HAVING COMPLIANCE TRACKING

(71) Applicant: Covidien LP, Mansfield, MA (US)

(72) Inventor: Jeffrey R. Ladd, Duxbury, MA (US)

(21) Appl. No.: 13/971,096

(22) Filed: Aug. 20, 2013

(51) Int. Cl. A61H 9/00

(52) U.S. Cl. CPC A61H 9/005
USPC 601/149

(57) ABSTRACT

A system for applying compression treatment to a wearer's body includes a compression garment positionable on the wearer's body. The garment includes an inflatable bladder and fasteners. The fasteners are electrically conductive and form part of an electric circuit. Connection of the fasteners closes the electric circuit and disconnection of the fasteners opens the circuit. A controller that provides air pressure to the garment is able to detect whether the electric circuit is opened or closed.

### BACKGROUND

A major concern for immobile patients and like persons are medical conditions that form clots in the blood, such as, deep vein thrombosis (DVT) and peripheral edema. Such patients and persons often include those undergoing surgery, anesthesia, extended periods of bed rest; etc. These blood clotting conditions generally occur in the deep veins of the lower extremities and/or pelvis. These veins, such as the iliac, femoral, popliteal and tibial, return deoxygenated blood to the heart. When blood circulation in these veins is retarded due to illness, injury, or inactivity, for example, there is a tendency for blood to accumulate or pool. A static pool of blood may lead to the formation of a blood clot. A major risk associated with this condition is interference with cardiovascular circulation. Most seriously, a fragment of the blood clot can break loose and migrate. A pulmonary embolus can form from the fragment potentially blocking a main pulmonary artery, which may be life threatening.

The conditions and resulting risks associated with patient immobility may be controlled or alleviated by applying intermittent pressure to a patient's limb (e.g., a leg) to assist in blood circulation. A conventional compression system typically incorporates a compression garment for applying compressive forces to the targeted area. The system delivers intermittent or cyclic pulses of compressed air to at least one inflatable chamber in the garment, which in turn inflates and compresses the body part on which the garment is worn. The cyclic inflation of the compression garment provides a non-invasive method of prophylaxis to reduce the likelihood of DVT and to improve blood flow. Clinicians may need to monitor patient compliance to ensure the desired compression treatment is being provided to the patient.

### SUMMARY

In one aspect, a system for applying compression treatment to a wearer's body includes a compression garment, a conduit, a garment connector, and a controller. The compression garment is positionable on the wearer's body and includes an inflatable bladder and fasteners. The conduit is in fluid communication with the inflatable bladder. The garment connector is attached to the conduit and is in fluid communication with the conduit. A controller is releasably connectable to the garment connector to establish fluid communication from the controller to the inflatable bladder via the conduit. The controller, the garment connector, the conduit, and the fasteners each include respective electrically conductive portions forming at least part of an electric circuit when the controller is operatively connected in fluid communication with the garment connector to receive pressurized fluid from the controller. The fasteners are arranged on the garment to close the electric circuit when the fasteners are engaged with one another to secure the garment to the body and to open the electric circuit when the fasteners are substantially disengaged from one another. The controller comprises detection circuitry for determining whether the compression garment is secured to the wearer's body based at least in part on detection of whether the electric circuit is open or closed.

In some embodiments, the fasteners include an electrically conductive loop component on the compression garment and an electrically conductive hook component on the compression garment. The electrically conductive loop and hook components are adapted to make electrical connection with each other upon engagement of the hook component with the loop component.

In certain embodiments, the detection circuitry is configured to monitor a characteristic of the electric circuit.

In some embodiments, the detection circuitry is configured to monitor the magnitude of the characteristic and, based at least in part on the magnitude of the characteristic, determine whether the engagement of the fasteners is secure.

In some embodiments, the controller further includes a controller connector in fluid communication with the controller and having an electrically conductive portion forming a part of the electric circuit when the controller is connected in fluid communication with the garment connector. The controller connector is releasably connectable with the garment connector to bring the controller into fluid communication with the inflatable bladder and to make electrical connection of the electrically conductive portion of the controller connector with the electrically conductive portion of the garment connector.

In certain embodiments, the electrically conductive portion of the controller connector includes an electrical contact.

In some embodiments, the electrically conductive portion of the garment connector includes an electrical contact configured to make an electrical connection with the electrical contact of the controller connector.

In some embodiments, the system further includes an electrical conductor electrically connecting one of the fasteners to the conduit.

In certain embodiments, the electrical conductor comprises a low voltage wire.

In some embodiments, the electrically conductive portion of the conduit includes a low voltage wire connected to the conduit.

In certain embodiments, the system further includes a plurality of inflatable bladders. Each inflatable bladder has a conduit fluidly connected to the inflatable bladder. The electrical conductor electrically connects the fasteners to only one of the conduits.

In some embodiments, the system further includes a plurality of inflatable bladders. Each inflatable bladder has a conduit fluidly connected to the inflatable bladder. The system further includes a dedicated electrical conductor for each conduit for electrically connecting the fasteners to the conduits.

In another aspect, a device for applying compression treatment to a wearer's body generally includes a compression garment, a conduit, and a connector. The compression garment is positionable on the wearer's body. The garment includes an inflatable bladder and fasteners. The conduit is in fluid communication with the inflatable bladder. The connector is attached to the conduit in fluid communication with the inflatable bladder. The connector, the conduit, and the fasteners each include respective electrically conductive portions forming at least part of an electric circuit when the connector is operatively connected in fluid communication with a controller to receive pressurized fluid from the controller. The fasteners are arranged on the garment to close the electric circuit when the fasteners are engaged with one another to secure the garment to the body and to open the electric circuit when the fasteners are substantially disengaged from one another.

In some embodiments, the fasteners include an electrically conductive loop component on the compression garment and an electrically conductive hook component on the compression garment. The electrically conductive loop and hook components are adapted to make electrical connection with each other upon engagement of the hook component with the loop component.

In still another aspect, a compression device for applying compression treatment to a wearer's body generally includes a compression garment, a conduit, and a connector. The compression garment is positionable on the wearer's body and includes an inflatable bladder for providing compressive treatment to the body and fasteners for securing the garment to the body. The fasteners are electrically conductive and form at least a part of an electric circuit. The fasteners are arranged to close the electric circuit when the fasteners are engaged and to open the electric circuit when the fasteners are disengaged. The conduit is in fluid communication with the inflatable bladder and includes an electric conductor disposed for communication with the electric circuit. The connector is attached to the conduit in fluid communication with the inflatable bladder and includes an electric conductor disposed for electrical communication with the electric conductor in the conduit. The connector is constructed to make a releasable fluid connection with a controller for receiving pressurized fluid from the controller and constructed to make electrical connection with the controller via the electric conductor of the connector to provide a signal to the controller to indicate when the compression garment is secured to the wearer's body.

In some embodiments, the electrically conductive fasteners and the electric conductors in the conduit and the connector form part of the electric circuit.

In certain embodiments, the fasteners comprise an electrically conductive loop component on the compression garment and an electrically conductive hook component adapted to make electrical connection with each other upon engagement of the hook component with the loop component.

In some embodiments, the compression device is combined with the controller. The controller includes a control unit configured to monitor a characteristic of the electric circuit for tracking the patient wearing the compression garment.

In certain embodiments, the control unit is configured to monitor the magnitude of the characteristic and determine whether the engagement of the fasteners is secure.

In yet another aspect, a controller for controlling a compression garment positionable on the wearer's body includes an electric input and detection circuitry. The electric input is adapted for connection to the compression garment for receiving an electrical signal from the garment. The detection circuitry is configured to monitor the electric input to obtain a reading associated with fasteners on the compression garment. One or more processors are configured to execute computer executable instructions for acquiring the reading from the detection circuitry and determining from the acquired reading if the fasteners of the compression garment are connected to each other. If the fasteners are determined to be connected to each other, the computer executable instructions increment a compliance timer.

In some embodiments, the computer executable instructions further comprise determining whether the reading from the detection circuitry exceeds a threshold above a reading indicative that the fasteners are connected to each other.

In certain embodiments, the computer executable instructions further include indicating that the connection of the fasteners is improper when the reading from the detection circuitry is determined not to be above the threshold.

In some embodiments, the computer executable instructions further comprise incrementing a compliance timer if it is determined from the reading that the fasteners are connected to each other.

In certain embodiments, the computer executable instructions further comprise monitoring the controller to determine if the controller is operating and incrementing a system timer if the controller is determined to be operating.

Embodiments can include one or more of the following advantages.

In some embodiments, compliance with the treatment regimen prescribed for a patient can be monitored by incrementing a compliance timer only when the fasteners of the compression sleeve are properly engaged with each other. Proper engagement of the fasteners corresponds to the compression garment being worn by the patient. The clinician may use the compliance information to take steps to assure that the full treatment regimen is completed.

In certain embodiments, the compression system can provide an indication that the fasteners are not connected. For example, a warning message may be presented on a display of a controller of the system.

In other embodiments, the compression system can determine whether, notwithstanding confirmation that the compression garment is connected around the patient's leg, that proper connection of the fasteners for proper compression treatment has been achieved. For example in the case of hook and loop fasteners a determination of the extent of overlap of the fasteners can be made.

In some embodiments the same components that supply fluid to the compression garment make up a portion of the electric circuit for indicating patient compliance. Similarly, the fasteners perform both a securement function and form a portion of the electric circuit.

Accordingly, these components facilitate implementation of an electric circuit for compliance monitoring with minimal additional burden on the clinician applying the compression garment to the wearer. For example, the compression garment can be secured to the wearer's body in the same manner as a compression garment that does not include a compliance monitoring circuit.

Other aspects, features, and advantages will be apparent from the description and drawings, and from the claims.

### BRIEF DESCRIPTION OF THE DRAWINGS

FIG. 1 is a front view of a compression garment with an outer cover and intermediate layers of a compression garment partially removed to show underlying layers.

FIG. 2 is a rear view of an inner layer of the compression device of FIG. 1.

FIG. 3 is a front view of the compression device of FIG. 1 with the outer cover completely removed.

FIG. 4 is a perspective view of a compression system including a controller and fragmentary portion of the compression garment of FIG. 1, shown with the outer cover completely removed as in FIG. 3.

FIG. 5 is an electrical circuit diagram of a garment connection verification circuit of the compression system of FIG. 4.

FIG. 6 is a schematic representation of the compression system of FIG. 4 showing the verification circuit of FIG. 5 and a pneumatic circuit of the compression garment.

FIG. 7 is a cross-section taken along line 7-7 of a tube of the compression garment of FIG. 4.

FIG. 8 is a fragmentary perspective view of connectors of the compression system of FIG. 4.

FIG. 9 is a flow chart for compliance monitoring using the verification circuit of FIG. 5.

FIG. 10 is a schematic of a compression system in which a tube carries a single conductor for electrical communication with loop components and another single conductor for electrical communication with hook components.

Corresponding reference characters indicate corresponding parts throughout the drawings.

### DETAILED DESCRIPTION

As used herein, the terms “proximal,” “distal,” and “intermediate” represent relative locations of components, parts and the like of a compression garment when the garment is worn. For example, a “proximal” component is disposed most adjacent to the wearer's torso, a “distal” component is disposed most distant from the wearer's torso, and an “intermediate” component is disposed generally anywhere between the proximal and distal components.

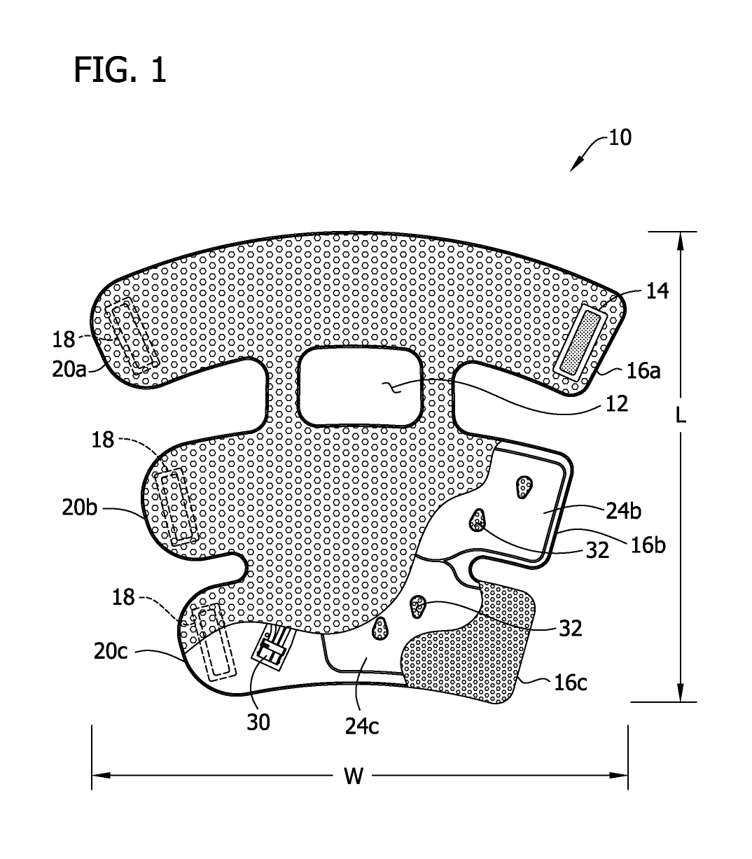

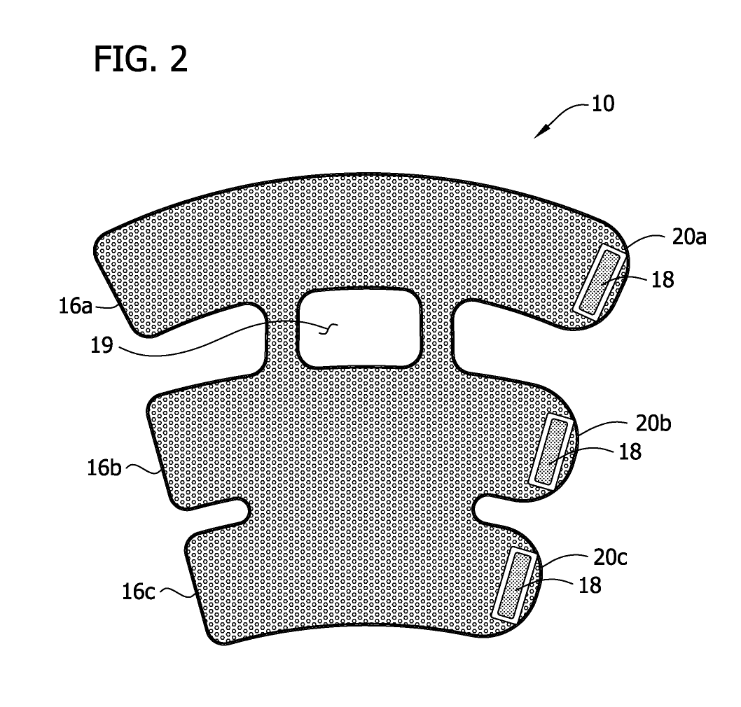

Referring now to FIGS. 1-5, a compression system 1 includes a compression garment 10 for applying sequential compression therapy to a limb of a wearer and a controller 5 for controlling operation of the compression device. As will be described in further detail below, the compression garment 10 includes electrically conductive loop components 14 and electrically conductive hook components 18 that can engage and disengage with one another to close and open an electric circuit that can be checked by the controller 5 to determine whether the compression garment 10 is secured properly to the wearer's body. The determination made by the controller 5 can be used to provide a signal to a clinician. Additionally or alternatively, the determination made by the controller 5 can be used to track patient compliance in using the compression garment 10.

The compression garment 10 can be a sleeve sized and shaped for being disposed around a leg of a wearer's body. For example, the garment 10 can have a width W for being wrapped around a full circumference of the leg and a length L for running from an ankle to a thigh of the leg. A knee opening 12 can be formed through the garment 10 for general alignment with the back of the knee when the garment is worn. This type of garment is generally referred to as a thigh-length garment. It will be understood that the compression garment 10 may come in different sizes, such as a knee length garment that extends from the ankle up to the calf of the leg. Additionally or alternatively, the compression garment 10 can be positionable about other parts of the wearer's body. For example, the garment 10 can be a foot cuff. While the garment 10 is described herein as applying sequential therapy, it should be appreciated that constant compression therapy is within the scope of this disclosure.

The loop components 14 are attached to an outer surface of the compression garment 10 at proximal, intermediate, and distal flaps 16a, 16b, 16c, respectively. Hook components 18 are attached to an inner surface of the compression garment at proximal, intermediate, and distal flaps 20a, 20b, 20c, respectively. In use, the hook components 18 of the proximal, intermediate, and distal flaps 20a, 20b, 20c engage the loop components 14 of the respective proximal, intermediate, and distal flaps 16a, 16b, and 16c to secure the compression garment 10 to the wearer's leg.

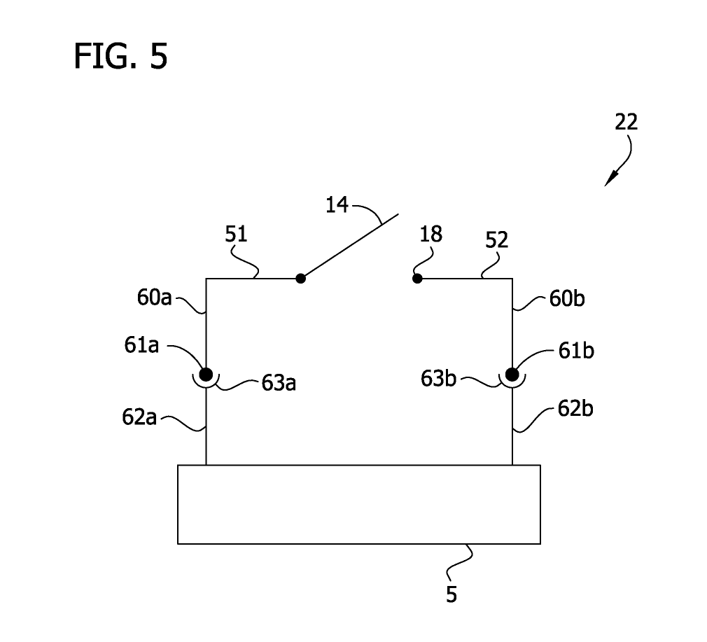

The loop components 14 and the hook components 18 are electrically conductive and are part of a securement verification circuit 22. The loop and hook components 14, 18 are represented in FIG. 5 as cooperating parts of a switch. Attachment of the loop and hook components 14, 18 closes the switch to complete the circuit 22, and disconnection of the loop and hook components 14, 18 opens the switch to open the circuit. The loop components 14 are connected to the controller 5 by electrical conductors including wires 51 and 63a. Similarly, the hook components 18 are connected to the controller 5 by electrical conductors including wires 52 and 63b. As described in further detail below, the controller 5 determines whether the loop and hook components 14, 18 are engaged based at least in part on the state of the circuit 22, thus tracking patient compliance in using the compression system 1.

The wires 51, 63a and 52, 63b can be electrically connected and disconnected by an output connector 28 and a garment connector 30. The connectors 28, 30 also provide for pneumatic connection of the compression garment 10 to the controller 5 and will be described in more detail hereinafter. It should be appreciated that positioning the wires 51, 63a and 52, 63b such that electrical and pneumatic connections are established together can facilitate tracking patient compliance in using the compression garment 10. For example, such simultaneous connection can ensure that the securement verification circuit 22 is operational whenever the compression garment 10 is pneumatically connected to the controller 5. This can reduce potential errors in compliance tracking that could otherwise occur if only one of the pneumatic and electrical connections were made. Additionally or alternatively, establishing electrical and pneumatic connections allows the securement verification circuit 22 to be substantially transparent to a clinician already familiar with making pneumatic connections between a compression garment and a controller using connectors similar to connectors 28, 30. Thus, for example, the securement verification circuit 22 can be implemented with little to no additional burden placed on the clinician.

The compression garment 10 has a proximal bladder 24a, an intermediate bladder 24b, and a distal bladder 24c. The bladders 24a, 24b, 24c are spaced apart longitudinally along the compression garment 10. Each inflatable bladder 24a, 24b, 24c can be placed in fluid communication with compressed fluid from the controller 5 via a proximal bladder tube 26a, an intermediate bladder tube 26b, and a distal bladder tube 26c, respectively. Ends of the tubes 26a, 26b, 26c are grouped together by the garment connector 30, which connects to the output connector 28 such that fluid communication is established between the controller 5 and each tube 26a, 26b, 26c. The controller 5 may be an air compressor under the control of a microprocessor that, for example, sequentially pressurizes the bladders. An exemplary air compressor is described in U.S. Pat. No. 5,876,359 to Bock, the entire disclosure of which is incorporated herein by reference. In some embodiments, the bladders 24a, 24b, 24c are configured to contain air pressurized to at least about 10 mm Hg (1333 Pa) to about 45 mm Hg (6000 Pa). The bladders 24a, 24b, 24c are repeatedly pressurizable, over several cycles, without failure. The bladders 24a, 24b, 24c can define openings 32 extending completely through the bladders 24a, 24b, 24c. While a specific configuration of the garment 10 and particularly the bladders 24a, 24b, 24c has been described, it should be appreciated that other configurations of the garment 10 are within the scope of this disclosure.

The controller 5 is disposed in a housing 7. A control panel 9 on the housing 7 can include, for example, controls (e.g., a keyboard, buttons, touchscreen, etc.) to input parameters to the controller 5. Additionally or alternatively, the control panel 9 can include indicators (e.g., lights, icons on a display screen, etc.) to indicate whether and/or to what extent a compliance condition has been met. The output connector 28 is connected to the housing 7 through conduit 8, which can be, for example, flexible tubing. The output connector 28 is releasably connectable with the garment connector 30 for pneumatically connecting the controller 5 to the bladders 24a, 24b, 24c of the garment 10 through the tube 8 and tubes 26a, 26b, 26c.

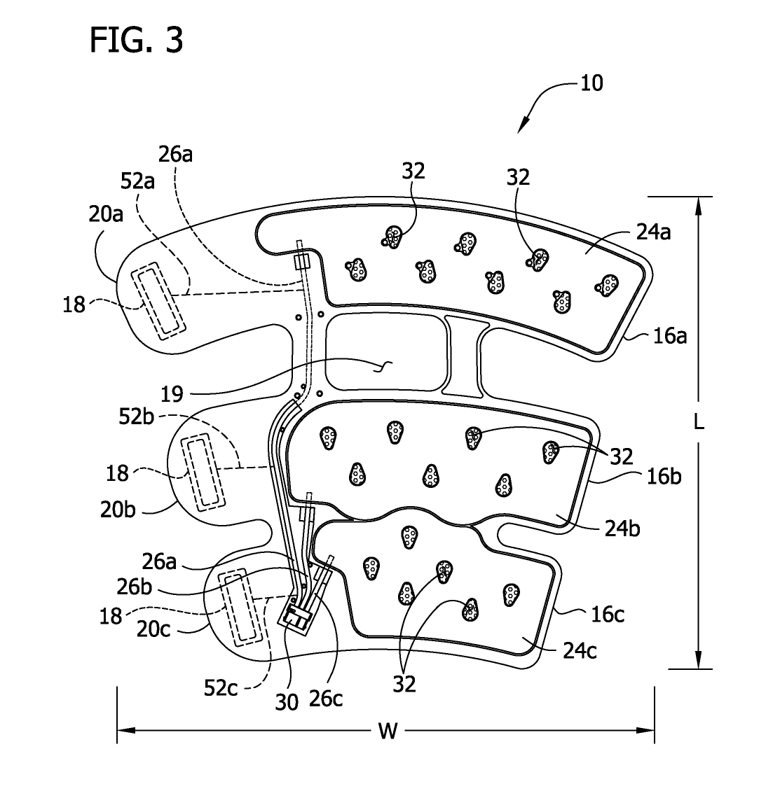

Referring to FIGS. 3 and 5-7, in addition to the pneumatic configuration of the compression system 1, the compression system 1 has an electrical configuration for use in detecting whether the compression garment 10 is secured to the wearer's leg. At least a portion of the loop components 14 and at least a portion of the hook components 18 are electrically conductive such that an electrical connection is established between the electrically conductive loop components 14 and the electrically conductive hook components 18 to complete the securement verification circuit 22. Substantial disengagement of the loop components 14 from the hook components 18 opens the securement verification circuit 22 (the open condition is shown schematically in FIG. 5). An example of conductive hook and loop components that can be used for the loop components 14 and the hook components 18 is Conductive Hook and Loop Part Number 20321-01, available from Inventables, Inc. of Chicago, Ill.

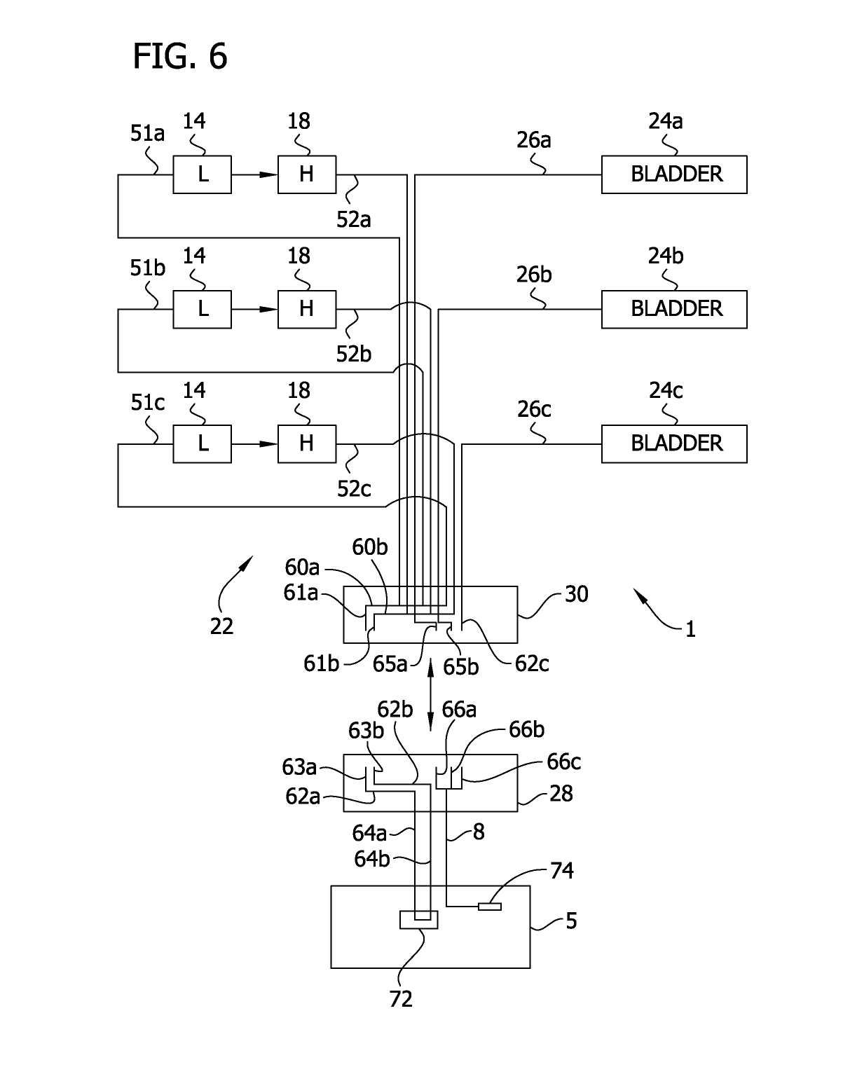

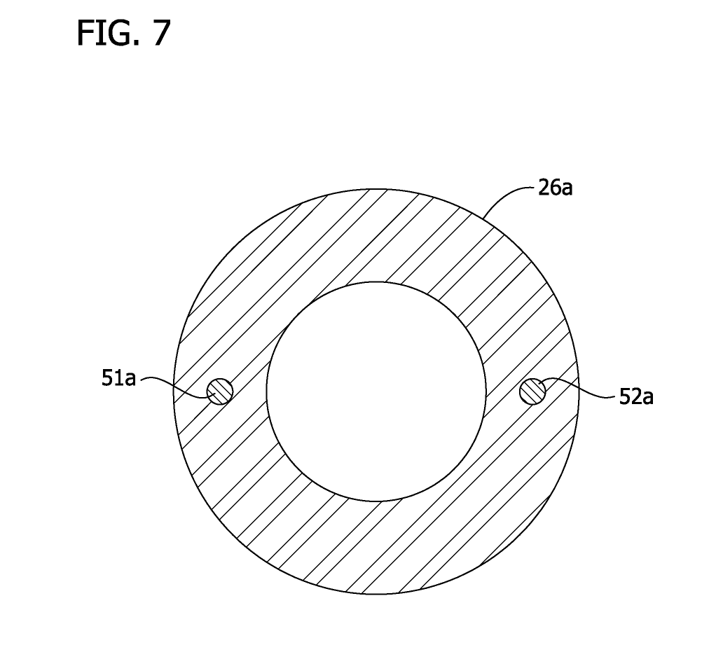

Wires 51a, 51b, 51c electrically connect the electrically conductive loop components 14 to the garment connector 30, and wires 52a, 52b, 52c electrically connect the electrically conductive hook components 18 to the garment connector 30. The loop component wires 51a-c and hook component wires 52a-c can be associated with one or more of the tubes 26a-c. In FIG. 6, at least the portions of the wires 51a-c and 52a-c shown as extending parallel to one or more of the tubes 26a-c may be considered to be attached and/or incorporated into the tube(s) 26a-c. For example, as shown in FIG. 7, the wires 51a and 52a can be located within a wall of the tube 26a such that the tube 26a electrically insulates each of the wires 51a and 52a. It should be appreciated that the pair of wires 51b and 52b can be similarly disposed within the tube 26b, and the pair of wires 51c and 52c can be similarly disposed within the tube 26c. It should be further appreciated that multiple pairs of wires can be disposed within a single tube. For example, the three pairs of wires Ma and 52a, 51b and 52b, and 51e and 52c can each be disposed within the tube 26a.

Portions of each of the wires 51a-c extend outside of the tube(s) 26a-c to make electrical connection with the electrically conductive loop components 14. Similarly, portions of each of the wires 52a-c extend outside of the tube(s) 26a-c to make electrical connection with the electrically conductive hook components 18. The wires 51, 52 may comprise low voltage (e.g., up to about 50 VAC/VDC with 0.1 to 0.5 A rating at 86° F.) wires suitable for conducting an electrical signal.

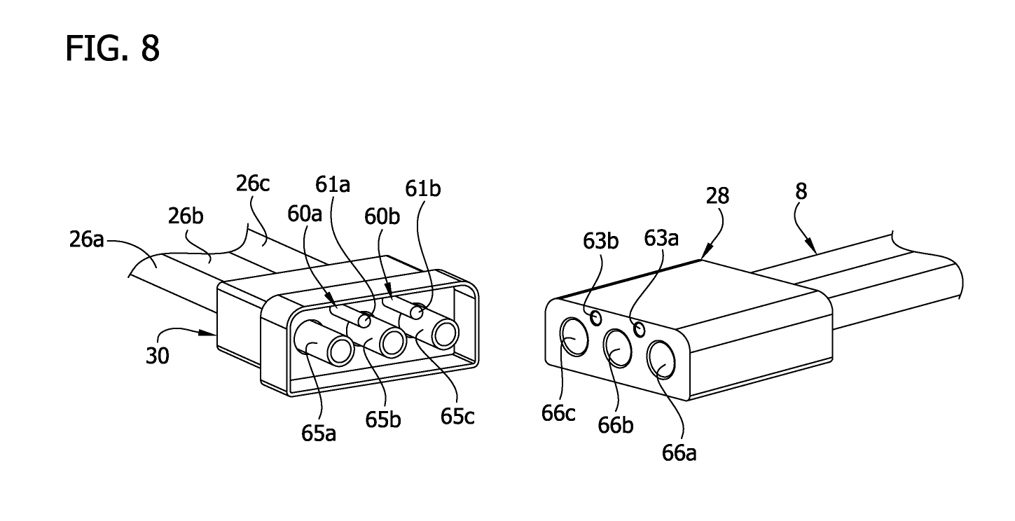

Referring now to FIGS. 6 and 8, the garment connector 30 includes a connector conductor 60a in electrical communication with the loop component wires 51a-c, and a connector conductor 60b in electrical communication with the hook component wires 52a-c to form part of the securement verification circuit 22. The connector conductor 60a includes an electric contact pin 61a in electrical communication with the loop component wires 51a-c and connector conductor 60b includes a separate electric contact pin 61b in electrical communication with the hook component wires 52a-c. The controller connector 28 includes a connector conductor 62a terminating at an electric socket contact 63a, and a connector conductor 62b terminating at an electric socket contact 63b. When the output connector 28 and the garment connector 30 are mated, the electric contact pin 61a is received in the electric contact socket 63a, and the electric contact pin 61b is received in the electric contact socket 63b. The connector conductor 62a is electrically connected to a wire 64a and the electric conductor 62b is electrically connected to a wire 64b. The wires 64a, 64b may be incorporated into the tubing 8 in a manner analogous to the incorporation of the wires 51a-c and 52a-c into the tubes 26a-c, for example, as described above.

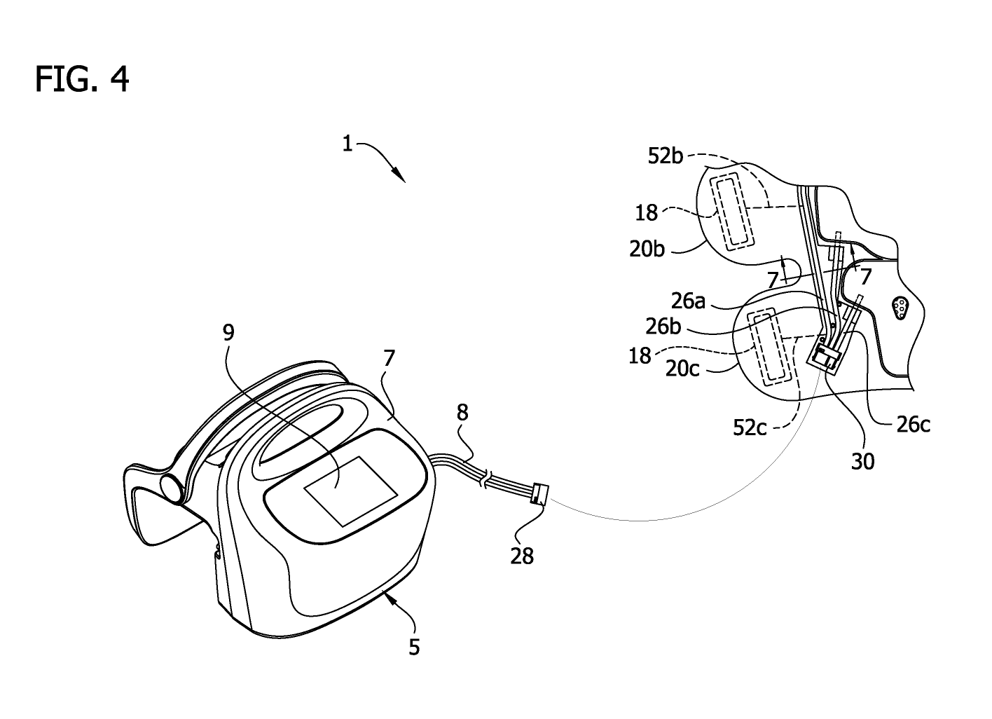

To make fluid connection with the bladders 24a, 24b, 24c, the garment connector 30 includes male terminals 65a, 65b, 65c to which the respective tubes 26a, 26b, 26c are attached in fluid communication. The output connector 28 includes female terminals 66a, 66b, 66c, to which the tubing 8 is attached in fluid communication. Mating the output connector 28 with the garment connector 30 makes fluid connection of the male terminals 65a-c with the respective female terminals 66a-c. It should be appreciated that, at the same time the fluid connection is made between the male terminals 65a-c and the female terminals 66a-c, an electrical connection is established between the electric contact pins 61a, 61b and the respective electric contact sockets 63a, 63b. Thus, the compression garment 10 and the controller 5 are both pneumatically and electrically connected by a single act of connecting the output connector 28 with the garment connector 30. The electric circuit 22 can indicate that fluid connection of the output connector 28 to the garment connector 30 has been achieved. For example, the connection of the output connector to the garment connector 30 can be indicated as an icon and/or light on the control panel 9 (FIG. 4).

The controller 5 includes detection circuitry 72 for determining whether the garment 10 is secured to the wearer's leg. The detection circuitry 72 monitors one or more characteristics of the securement verification circuit 22, (e.g., current and/or voltage). The wires 64a, 64b terminate at the detection circuitry 72. The tubing 8 is connected to a pump 74 within the controller 5. The pump 74 may include its own control unit (not shown) or share a control unit associated with the detection circuitry 72 to control operation of the pump 74 to inflate and deflate the bladders 24a-c to provide compression treatment.

The securement verification circuit 22 can operate with a current below a threshold (e.g., below about 200 μA). Additionally or alternatively, the securement verification circuit 22 can operate with a single fault (e.g., less than about 1 A) limit. For example, detection of current at or above the single fault limit can result in a shutdown of power to the securement verification circuit 22. Such a threshold and/or single fault limit can protect the patient and/or clinician in the event of inadvertent contact with the securement verification circuit 22 (e.g., contact with the hook components 18).

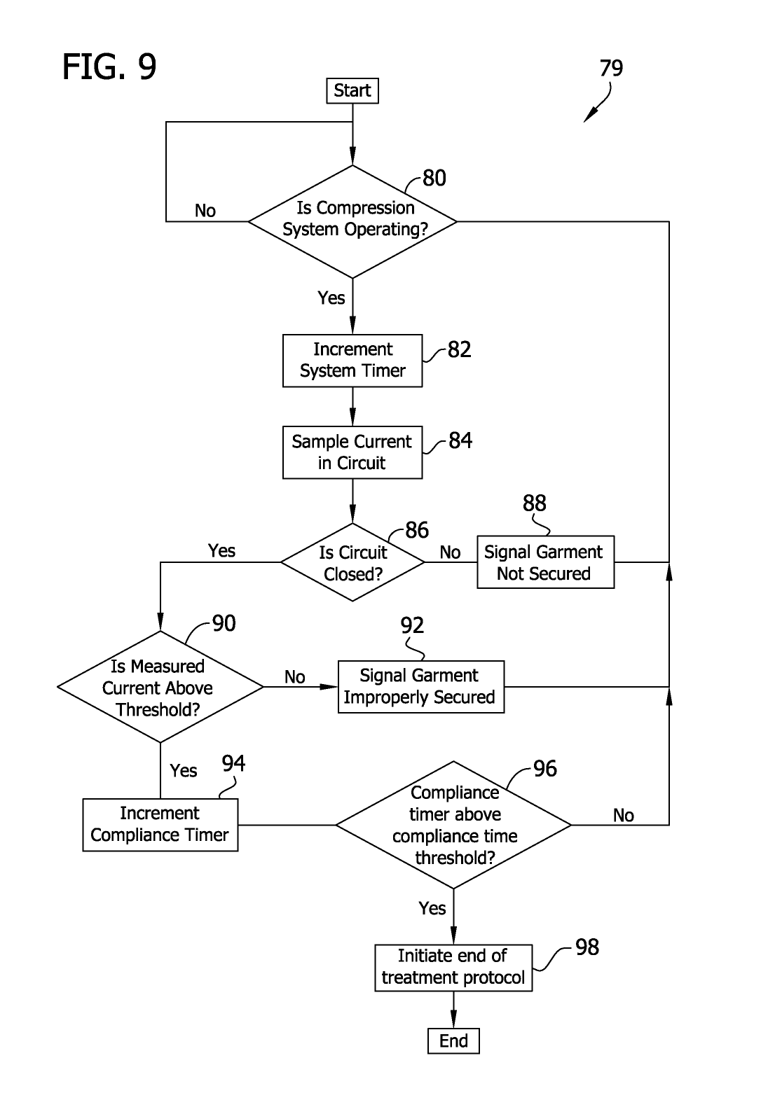

Referring now to FIGS. 4-6 and 9, FIG. 9 is a flowchart of an exemplary process 79 for tracking compliance of a patient using the compression system 1. The process 79 may be implemented, for example, through computer executable instructions carried out by the controller 5 (e.g., one or more processors carried by or otherwise associated with the controller 5). In general, the process 79 makes use of the electrical configuration of the compression system 1 to monitor patient compliance with the prescribed use of the compression garment 10.

Upon activation of the controller 5, operation of the compression system 1 is detected at block 80. Examples of parameters that can be detected at block 80 include an electrical signal from the pump 74 (FIG. 6) and/or a measurement of a change in pressure in one or more of the bladders 24a-c. If operation of the compression system 1 is not detected at block 80, then the detection at block 80 is periodically repeated (e.g., at a fixed increment of time or upon receiving a user input) to re-check for operation of the compression system 1. If the compression system 1 is operating, a system timer is incremented at block 82. The system timer incremented at block 82 keeps track of how long the compression system 1 is on and in operation.

The detection circuitry 72 of the controller 5 samples the current in the securement verification circuit 22 at block 84. Based at least in part on the magnitude of the current measured at block 84, a determination is made at block 86 whether the securement verification circuit 22 is closed. If the measured current reading is zero, the determination is made at block 86 that the circuit 22 is open and a signal is produced at block 88, indicating that the garment 10 is not properly secured on the patient's leg. The signal produced at block 88 may take the form of a visual indication such as a warning message on the control panel 9 or another suitable display of the controller 5 and/or an audible indication or any other way of indicating to a clinician that that the garment 10 is not properly secured to the patient. In response to the signal produced at block 88, the clinician can examine the connection of the electrically conductive loop components 14 and the electrically conductive hook components 18 to make sure there is proper connection.

If the securement verification circuit 22 is determined to be closed at block 86, the magnitude of the measured current is compared to a certain current threshold at block 90. If the current is nonzero but its magnitude is not above the threshold, an indication is produced at block 92 to indicate the connection that is present is not optimal for the best compression treatment. For example, there may be insufficient overlap of the electrically conductive loop components 14 with the electrically conductive hook components 18, indicating that a tighter fit of the garment 10 around the wearer's leg is needed. The form in which this condition is indicated may be similar to the indication at block 88. However, it should be appreciated that the condition at block 88, where there is essentially no connection between the electrically conductive loop components 14 and the electrically conductive hook components 18, is different from the condition indicated at block 92 and the message associated with these different conditions can be correspondingly different. For example, the indication on the control panel 9 for block 88 can be “No Connection,” whereas the indication on the control panel 9 for block 92 can be “Loose Connection.” These different messages can, for example, facilitate diagnosis of the source of the non-compliant use of the garment 10.

If the measured current is above the threshold, for example greater than or equal to 25 μA, the compliance timer is incremented at block 94. Thus, it will be understood that the compliance timer 94 is incremented only when the garment 10 is properly secured on the wearer's leg. The compliance timer data can be stored (e.g., in a memory associated with the controller 5) for later access. Additionally or alternatively, the data from the system timer at block 82 can be stored and later compared to the data from the compliance timer at block 94 (e.g., as by taking a ratio) to show the amount of time during which the compression system 1 was operating in a compliant manner. In this way, better and more complete information about a patient's usage is available. This can help the clinician to determine among other things, completion of treatment and alternative conditions for ensuring proper use of the compression system 1 by the patient.

The compliance timer is compared to a compliance time threshold (e.g., a threshold for effective therapeutic treatment) at block 96. If the compliance timer is less than or equal to the compliance time threshold, the operation of the compression system 1 is again determined at block 80. If the compliance timer is above the compliance time threshold, an end- of-treatment protocol is initiated at block 98. For example, the end-of-treatment protocol can include providing a signal on the control panel 9, while compression treatment continues to be applied to the wearer's leg. As another example, the end-of-treatment protocol can include stopping operation of the pump 74 and, in certain instances, also providing a signal on the control panel 9. Additionally or alternatively, the end-of-treatment protocol can include writing information to memory that forms part of the detection circuitry 72 such that the contents of the memory can be later read via the control panel 9 and/or via communication with a remote server.

While certain embodiments have been described, other embodiments are possible.

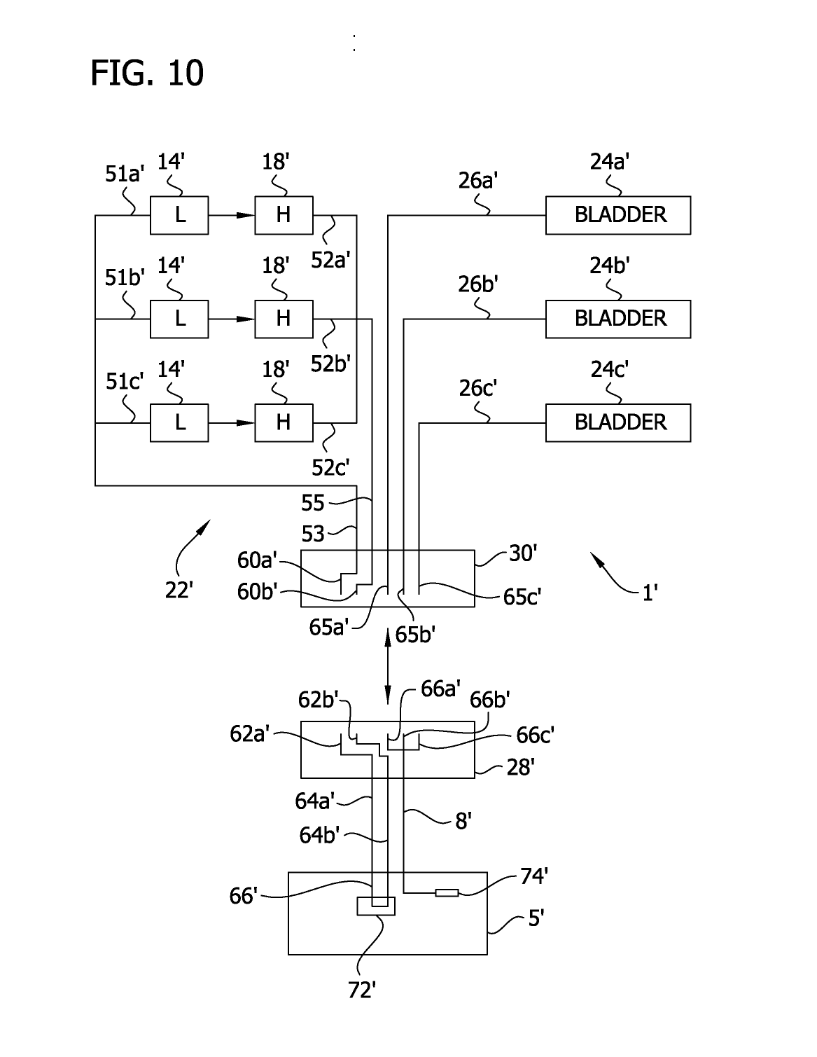

For example, while the above-described securement verification circuits have been described as including a single circuit extending from electrically conductive loop components and electrically conductive hook components to a controller, other arrangements are additionally or alternatively possible. For example, as shown in FIG. 10, a securement verification circuit 22′ includes loop component wires 51a′-c′ merged into a first single conductor 53 associated with the tube 26a′, and the hook component wires 52a′-c′ can be merged into a second single conductor 55 associated with the tube 26a′. The reference characters in FIG. 10 are the same as shown in FIG. 6 for corresponding parts, plus the addition of a prime.

As another example, while the above-described securement verification circuits have been described as extending from a compression garment to a controller, other arrangements are additionally or alternatively possible. For example, a complete securement verification circuit may be located on the compression garment and another circuit for detecting whether the securement verification circuit is opened or closed may extend from the controller to the garment.

As yet another example, while compression garments have been described as including three electrically conductive hook components and three corresponding electrically conductive loop components, other arrangements are additionally or alternatively possible. For example, a compression garment can have fewer or greater electrically conductive loop components and/or fewer or greater electrically conductive hook components. As another example, a compression garment can have a larger number of one of the electrically conductive loop components or the electrically conductive hook components such that the number of electrically conductive loop components is not the same as the number of electrically conductive hook components.

Embodiments of the disclosure may be implemented with computer-executable instructions stored on a tangible storage device. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

When introducing elements of the present disclosure or the preferred embodiments(s) thereof, the articles “a”, “an”, and “the” are intended to mean that there are one or more of the elements. The terms “comprising”, “including” and “having” are intended to be inclusive and mean that there may be additional elements other than the listed elements.

As various changes could be made in the above constructions, products, and methods, it is intended that all matter contained in the above description and shown in the accompanying drawings shall be interpreted as illustrative and not in a limiting sense.

What is claimed is:

1. A system for applying compression treatment to a wearer's body, the system comprising:
a compression garment positionable on the wearer's body, the garment comprising an inflatable bladder and fasteners;
a conduit in fluid communication with the inflatable bladder;
a garment connector attached to the conduit and in fluid communication with the conduit;
a controller releasably connectable to the garment connector to establish fluid communication from the controller to the inflatable bladder via the conduit, the controller, the garment connector, the conduit, and the fasteners each comprising respective electrically conductive portions forming at least part of an electric circuit when the controller is operatively connected in fluid communication with the garment connector to receive pressurized fluid from the controller, the fasteners are arranged on the garment to close the electric circuit when the fasteners are engaged with one another to secure the garment to the body and to open the electric circuit when the fasteners are substantially disengaged from one another, and the controller comprises detection circuitry configured to determine whether the compression garment is secured to the wearer's body based at least in part on detection of whether the electric circuit is open or closed.

2. The compression treatment system set forth in claim 1 wherein the fasteners comprise an electrically conductive loop component on the compression garment and an electrically conductive hook component on the compression garment, the electrically conductive loop and hook components adapted to make electrical connection with each other upon engagement of the hook component with the loop component.

3. The compression treatment system set forth in claim 1 wherein the detection circuitry is configured to monitor a characteristic of the electric circuit.

4. The compression treatment system set forth in claim 3 wherein the detection circuitry is configured to monitor a magnitude of the characteristic and, based at least in part on the magnitude of the characteristic, determine whether the engagement of the fasteners is secure.

5. The compression treatment system as set forth in claim 1 wherein the controller further comprises a controller connector in fluid communication with the controller and having an electrically conductive portion forming a part of the electric circuit when the controller is connected in fluid communication with the garment connector, the controller connector being releasably connectable with the garment connector to bring the controller into fluid communication with the inflatable bladder and to make electrical connection of the electrically conductive portion of the controller connector with the electrically conductive portion of the garment connector.

6. The compression treatment system as set forth in claim 1 further comprising an electrical conductor electrically connecting one of the fasteners to the conduit.

7. The compression treatment system as set forth in claim 6 wherein the electrical conductor comprises a low voltage wire.

8. The compression treatment system as set forth in claim 7 wherein the electrically conductive portion of the conduit comprises a low voltage wire connected to the conduit.

9. The compression treatment system as set forth in claim 6 further comprising a plurality of inflatable bladders, each inflatable bladder having a conduit fluidly connected to the inflatable bladder, wherein the electrical conductor electrically connects the fasteners to only one of the conduits.

10. The compression treatment system as set forth in claim 6 further comprising a plurality of inflatable bladders, each inflatable bladder having a conduit fluidly connected to the inflatable bladder, the system further comprising a dedicated electrical conductor for each conduit for electrically connecting the fasteners to the conduits.

11. A compression device for applying compression treatment to a wearer's body, the compression device comprising:
a compression garment positionable on the wearer's body, the garment comprising an inflatable bladder for providing compressive treatment to the body and fasteners for securing the garment to the body, the fasteners being electrically conductive and forming at least a part of an electric circuit, the fasteners being arranged to close the electric circuit when the fasteners are engaged and to open the electric circuit when the fasteners are disengaged;
a conduit in fluid communication with the inflatable bladder and including an electric conductor disposed for communication with the electric circuit;
a connector attached to the conduit in fluid communication with the inflatable bladder and including an electric conductor disposed for electrical communication with the electric conductor in the conduit, the connector being constructed to make a releasable fluid connection with a controller for receiving pressurized fluid from the controller and constructed to make electrical connection with the controller via the electric conductor of the connector to provide a signal to the controller to indicate when the compression garment is secured to the wearer's body.

12. The compression device as set forth in claim 11 wherein the electrically conductive fasteners and the electric conductors in the conduit and the connector form part of the electric circuit.

13. The compression device set forth in claim 11 wherein the fasteners comprise an electrically conductive loop component on the compression garment and an electrically conductive hook component adapted to make electrical connection with each other upon engagement of the hook component with the loop component.

14. The compression device set forth in claim 11 in combination with the controller, the controller including a control unit configured to monitor a characteristic of the electric circuit for tracking the patient wearing the compression garment.

15. The compression device set forth in claim 14 wherein the control unit is configured to monitor the magnitude of the characteristic and determine whether the engagement of the fasteners is secure.

16. A controller for controlling a compression garment positionable on the wearer's body, the controller comprising:
an electric input adapted for connection to the compression garment for receiving an electrical signal from the garment;
detection circuitry configured to monitor the electric input to obtain a reading associated with fasteners of the compression garment;
one or more processors configured to execute computer executable instructions for,
acquiring the reading from the detection circuitry,
determining from the acquired reading if the fasteners of the compression garment are connected to each other, and
if the fasteners are determined to be connected to each other, incrementing a compliance timer.

17. A controller as set forth in claim 16 wherein the computer executable instructions further comprise determining whether the reading from the detection circuitry exceeds a threshold above a reading indicative that the fasteners are connected to each other.

18. A controller as set forth in claim 17 wherein the computer executable instructions further comprise indicating that the connection of the fasteners is improper when the reading from the detection circuitry is determined not to be above the threshold.

19. A controller as set forth in claim 16 wherein the computer executable instructions further comprise incrementing a compliance timer if it is determined from the reading that the fasteners are connected to each other.

20. A controller as set forth in claim 19 wherein the computer executable instructions further comprise monitoring the controller to determine if the controller is operating and incrementing a system timer if the controller is determined to be operating.
